(19) United States
(12) Patent Application Publication
(10) Pub. No.: US 2024/0048864 A1
(43) Pub. Date: Feb. 8, 2024

(54) APPARATUS FOR CAPTURING AN IMAGE AND DETERMINING AN AMBIENT LIGHT INTENSITY

(71) Applicant: ams International AG, Jona (CH)

(72) Inventors: Jian LIU, Plano, TX (US); Zoe TANG, Nanshan District (CN)

(21) Appl. No.: 18/269,049

(22) PCT Filed: Dec. 17, 2021
(86) PCT No.: PCT/EP2021/086650

§ 371 Date: Jun. 22, 2023

(30) Foreign Application Priority Data
Dec. 22, 2020 (GB) 2020408.7

(51) Int. Cl. H04N 25/706; G01J 1/42; G01J 1/04; H04N 23/69

(52) U.S. Cl. CPC H04N 25/706; G01J 1/4204; G01J 1/0488; H04N 23/69

(57) ABSTRACT

An apparatus includes a body defining an aperture. The apparatus also includes an image sensor including an array of sensing elements. The apparatus further includes an ambient light sensor. The image sensor and the ambient light sensor are each arranged to receive radiation from the aperture.

### TECHNICAL FIELD OF THE DISCLOSURE

This disclosure relates to an apparatus for capturing an image and determining an ambient light intensity. Particularly but not exclusively, the apparatus may have application in a mobile electronic device such as, for example, a mobile telephone or a tablet.

### BACKGROUND OF THE DISCLOSURE

Many electronic mobile devices comprise a screen for displaying information and an ambient light sensor for determining an ambient light level of the electronic mobile device. Examples of such mobile devices include mobile telephones and tablets. In use, the determined ambient light level of the electronic mobile device may be used to control a brightness of the screen. For example, the brightness of the screen may be increased when the ambient light level is higher and decreased when the ambient light level is lower. In this way, the brightness of the screen can be optimized in dependence on ambient lighting conditions.

Many existing electronic mobile devices comprise a body and the screen is provided on a surface of this body. Typically, the screen does not occupy the entire surface of the body but is surrounded by a peripheral bezel region. Other components of the electronic mobile device may be provided on a portion of the body that corresponds to the bezel. It is desirable to maximize the ratio of the size of the screen to the size of the surface of the body on which it is provided (and to minimize the size of the surrounding bezel). In other words, for a given size of body, it is desirable to provide as large a screen as possible. In some existing electronic devices, the ambient light sensor is provided on the bezel. However, this increases the size of the bezel and reduces the size of the screen, which is undesirable.

In one alternative prior art arrangement, the screen comprises an organic light emitting device (OLED) display that is partially transparent and the ambient light sensor is provided behind the screen. Such embodiments exploit the transmissive characteristics of the OLED screen. However, such a solution is not applicable to liquid crystal display (LCD) screens, which is the screen technology employed a significant majority of the mobile telephone market, because LCD screens are typically opaque.

Some existing electronic mobile devices comprise a camera for capturing images. The camera may comprise an image sensor comprising an array of sensing elements (also referred to as pixels). In one prior art arrangement, an electronic device includes an image sensor comprising a pixel array. The pixel array includes a light sensing area and an imaging area. The light sensing area can be used either: to detect an illumination intensity; or in combination with the imaging area to acquire an image. That is, the light sensing area of the image sensor can sometimes be used as an ambient light sensor and sometimes be used (in combination with the imaging area) to acquire an image.

It is an aim of the present disclosure to provide an arrangement comprising an ambient light sensor that address one or more of the problems associated with prior art arrangements, whether identified herein or otherwise, or at least provides a useful alternative to prior art arrangements.

### SUMMARY

In general, this disclosure proposes to overcome the problems in existing arrangements by providing an arrangement having both an image sensor and an ambient light sensor which each receive radiation (for example visible light) from a common aperture. This arrangement is advantageous since it allows the ambient light sensor to be integrated into a camera module of a mobile electronic device. For example, this allows the ambient light sensor and the image sensor to share a common support or printed circuit board (PCB). Advantageously, this can reduce the size of a bezel of the mobile electronic device. In turn, this allows the size of a screen of the mobile electronic device to be increased. The proposed solution does not require a transmissive screen and therefore can be used with mobile electronic devices comprising an LCD display. Furthermore, by supplying both an image sensor and a separate ambient light sensor, the two sensors can each be separately optimised for their intended uses.

According to a first aspect of the present disclosure there is provided an apparatus comprising: a body defining an aperture; an image sensor comprising an array of sensing elements; and an ambient light sensor; wherein the image sensor and the ambient light sensor are each arranged to receive radiation from the aperture.

Advantageously, the apparatus according to the first aspect of the disclosure comprises both an image sensor and an ambient light sensor which each receive radiation (for example visible light) from a common aperture. This arrangement is advantageous since it allows the ambient light sensor to be integrated into a camera module of a mobile electronic device. For example, the body and image sensor may form part of a camera module of a mobile electronic device with which the ambient light sensor has been integrated. This allows the ambient light sensor and the image sensor to share a common support or printed circuit board (PCB). Advantageously, this allows for a reduction in the size of the bezel of a mobile electronic device comprising the apparatus according to the first aspect of the disclosure (relative to a mobile electronic device comprising a camera module and a separate ambient light sensor). In turn, this allows the size of a screen of the mobile electronic device to be increased. The apparatus according to the first aspect of the disclosure is particularly, though not exclusively, suitable for use as a front facing camera module of a mobile electronic device (i.e. a camera module provided on the same surface as the screen of the mobile electronic device).

The proposed solution does not require a transmissive screen (for example phones comprising an LCD display). In addition, such an arrangement can reduce the amount of background signal generated by a screen of the mobile electronic device. This allows for more accurate measurement of ambient light levels and/or reduces the complexity of calibration of such ambient light level measurements. Furthermore, by supplying both an image sensor and a separate ambient light sensor, the two sensors can each be separately optimised for their intended use.

A first type of prior art mobile electronic device comprises a camera module and a separate ambient light sensor module, both of which are provided on the bezel of the mobile electronic device. Compared to such known systems, the apparatus according to the first aspect of the disclosure allows for a reduction in the size of the bezel of a mobile electronic device comprising the apparatus according to the first aspect of the disclosure (relative to a mobile electronic device comprising a camera module and a separate ambient light sensor module). In turn, this allows the size of a screen of the mobile electronic device to be increased.

A second type of prior art mobile electronic device also comprises a camera module and a separate ambient light sensor module, the camera module provided on the bezel of the mobile electronic device and the ambient light sensor module provided behind a display screen of the mobile electronic device. However, this second type of prior art mobile electronic device requires a display screen that is transparent such as, for example, an OLED display screen. Furthermore, with this second type of prior art mobile electronic device, the display screen itself emits light that can contribute a significant (and variable) background signal for the ambient light sensor. This background signal needs to be taken into account using a suitable calibration or correction technique. Compared to such known systems, the apparatus according to the first aspect of the disclosure can be used with any type of display screen technology (for example LCD display screens). Furthermore, the compared to the second type of prior art mobile electronic device, the apparatus according to the first aspect of the disclosure can simplify the calibration and/or correction techniques for ambient light measurements and may increase the accuracy of such ambient light measurements.

A third type of prior art mobile electronic device includes an image sensor comprising a pixel array. The pixel array includes a light sensing area and an imaging area. The light sensing area can be used either: to detect an illumination intensity; or in combination with the imaging area to acquire an image. That is, the light sensing area of the image sensor can sometimes be used as an ambient light sensor and sometimes be used (in combination with the imaging area) to acquire an image. Compared to such known systems, the apparatus according to the first aspect of the disclosure provides an image sensor and a separate ambient light sensor, which allows an image to be captured whilst simultaneously measuring an ambient light level. Furthermore, by supplying both an image sensor and a separate ambient light sensor, the two sensors can each be separately optimised for their intended uses. For example, it may be desirable for an image sensor may be optimised to maximise a density of sensing elements (pixels) and therefore to provide optimum sensitivity of the small individual sensing elements or pixels. In contrast, it may be desirable for an ambient light sensor to use a larger sensing element having a greater dynamic range (to allow it to operate both in high and low ambient light levels).

The apparatus according to the first aspect of the present disclosure may be an assembly or module that can, in use, form part of a mobile electronic device. For example, apparatus according to the first aspect of the present disclosure may provide a camera module for a mobile electronic device. The body defining the aperture may, in use, be engaged with, mounted to, or connected to a body of a mobile electronic device. In use, the image sensor and the ambient light sensor may be housed in a volume defined by the body defining the aperture and the body of a mobile electronic device.

As referred to herein the image sensor comprising an array of sensing elements is intended to mean an array of photosensitive elements each of which is operable to produce a signal in response to a received dose of radiation (for example visible light). That is, the image sensor is intended to mean a portion of a sensor which converts received radiation (for example visible light) into electrical signals and which defines the pixel geometry of the sensor. The image sensor may comprise, for example, an active-pixel sensor technology. For example, the image sensor may comprise, for example, an array of complimentary metal-oxide semiconductor (CMOS) pixels. As referred to herein the image sensor may or may not also comprise any associated memory buffer or logic circuitry. For example, a two-layer stacked CMOS sensor comprising may comprise a pixel die bonded to a logic circuit die. Similarly, a three-layer stacked CMOS sensor may comprise a pixel die, a memory die (for example providing dynamic random access memory, DRAM) and a logic circuit die. As used herein, the term image sensor is intended to include the pixel die but may or may not include the other dies.

The ambient light sensor may comprise any type of photodetector. For example, the ambient light sensor may comprise one or more phototransistors, photodiodes and/or photonic integrated circuits.

The array of sensing elements of the image sensor may be formed on an image sensor die and the ambient light sensor may be formed on a separate ambient light sensor die.

It will be appreciated that separate dies may be formed from separate pieces of semi-conducting material (and the separate dies may be stacked or otherwise connected to each other).

The separate dies of the image sensor and the ambient light sensor may both be supported by a common support substrate.

For example, the image sensor die and the ambient light sensor die may both be mounted on a common printed circuit board (PCB). In some embodiments, the image sensor die and the ambient light sensor die may both be mounted separately on a common printed circuit board (PCB)

The ambient light sensor may be disposed on an opposite side of the common support substrate to the image sensor.

For such embodiments, the image sensor may be disposed in a side or surface of the support substrate facing the aperture. One or more hole, through bores or apertures may be provided in the support substrate in the vicinity of the ambient light sensor. This may increase a signal received by the ambient light sensor.

The image sensor die and the ambient light sensor die may be stacked to form a three-dimensional integrated circuit.

For example, the image sensor die and the ambient light sensor die may be interconnected using through-silicon vias (TSV).

The image sensor and the ambient light sensor may be formed using different process nodes.

It will be appreciated that the image sensor and the ambient light sensor being formed using different process nodes is intended to mean that the smallest features formed on the image sensor are different to the smallest features formed on the ambient light sensor. For example, the ambient light sensor may comprise one or more photodetectors formed from a 180 nm process node whereas the image sensor may comprise an array of sensing elements that define a plurality of image pixels and which may be formed from a significantly smaller process node. For example, in some embodiments, the image sensor may comprise the pixel die of a stacked CMOS image sensor (and the ambient light sensor may be formed on another die of the stacked CMOS image sensor). The pixel die of a stacked CMOS image sensor may, for example, be formed from a 90 nm process node, a 45 nm process node or a smaller process node. The pixel die of a stacked CMOS image sensor may, for example, use backside illumination (BSI) technology.

The apparatus may further comprise an optical element supported by the body and disposed in the vicinity of the aperture. The optical element may be arranged to project at least a portion of the radiation received by the aperture onto the image sensor.

The optical element may comprise a lens. It will be appreciated that the lens may be a compound lens comprising a plurality of lens elements. The lens may be arranged to form an image of a field of view on the image sensor.

The optical element may comprise a fixed-focus lens.

Alternatively, the optical element may comprise a lens provided with an adjustment mechanism operable to control a focal length of the lens and/or a position of the lens relative to the image sensor.

For example, the lens may be provided with a voice coil motor (VCM) to allow free movement of the lens (relative to the image sensor).

The image sensor may be disposed between the aperture defined in the body and the ambient light sensor.

Such an arrangement may be described as having the ambient light sensor positioned behind the image sensor. Such an arrangement is advantageous in that it allows both the ambient light sensor and the image sensor to overlap and to occupy substantially the same position on a bezel of a mobile electronic device comprising the apparatus according to the first aspect of the disclosure. In turn, this allows the size of a screen of the mobile electronic device to be increased.

It will be appreciated that since the ambient light sensor is arranged to receive radiation from the aperture, the apparatus according to the first aspect of the disclosure may be considered to comprise an optical pathway from the aperture to the ambient light sensor.

The apparatus may further comprise at least one light guide arranged to receive a portion of light from the aperture and to guide said portion of light from the aperture to the ambient light sensor.

For such embodiments, it may be challenging to provide an ambient light sensor with a sufficient field of view.

For embodiments wherein the image sensor is disposed between the aperture defined in the body and the ambient light sensor, the at least one light guide may be arranged to receive the portion of light from the aperture and to guide said portion of light from the aperture around the image sensor and to the ambient light sensor.

The apparatus may comprise a plurality of light guides, each arranged to receive a portion of light from the aperture and to guide said portion of light from the aperture to the ambient light sensor.

Advantageously, the provision of a plurality of light guides can improve the field of view of the ambient light sensor.

Optionally, the ambient light sensor may comprise a plurality of light sensing elements. Each of the plurality of light guides may be arranged to receive a portion of light from the aperture and to guide said portion of light from the aperture to a different one of the plurality of light sensing elements.

The apparatus may comprise a diffusor arranged to scatter light received by the plurality of light guides before it is incident on the ambient light sensor.

Such a diffusor can improve the field of view of the ambient light sensor. Each of the 25 plurality of light guides may be provided with, or may act as, a diffusor. For example, a diffusor may be provided at or proximate to an entrance to each of the plurality of light guides. Each diffusor may be substantially cover an entrance of a corresponding light guide. Each such diffusor may be provided as a separate optical component (to a corresponding light guide) and which is arranged to scatter light incident thereon. Alternatively, each such diffusor may be integrated with a corresponding light guide. For example, each such diffusor may be provided by a surface of each light guide (which surface may define an entrance of the light guide) that is provided with a texture or surface roughness that is arranged to scatter light which enters the light guide.

The at least one light guide may be arranged to receive a portion of light scattered to a side or edge of the optical element and to guide said portion of light scattered to a side or edge of the optical element to the ambient light sensor.

It will be appreciated that light which is scattered to a side or edge of the optical element may comprise light which is scattered out of the lens in a direction generally away from an optical axis of the optical element. That is, such that light scattered to a side or edge of the optical element propagates in a direction having at least a component that is generally perpendicular to the optical axis of the optical element.

For example, the optical element may be a lens, which may be a single lens element or a compound lens. A single lens element may comprise two opposed surfaces at least one of which is either concave or convex. For example, the optical element may comprise a lens element having two opposed convex surfaces. The side or edge of a single lens element may be a surface of the lens disposed between the two opposed surfaces. It will be appreciated that for a compound lens scattering of light to the side or edge of the optical element will in general include light which exits the compound lens in between the individual lens elements.

Such an arrangement may be particularly suitable for embodiments using a fixed-focus lens. The lens may be supported by a support structure such as, for example, the body or an intermediate member connected thereto. For example, the side or edge of the lens may be in contact with, or otherwise connected to, the support structure. In existing camera modules, at least the portion of the support structure that contacts the side or edge of the lens may be opaque. This can prevent background light that bypasses the lens from being incident on the image sensor. In some embodiments of the present disclosure, the at least one light guide may be at least partially formed in the support structure extending from one or more positions to a side or edge of the lens and to the ambient light sensor. The support structure may be otherwise generally opaque.

The at least one light guide may be arranged to receive a portion of light from the aperture that is not incident on the optical element to guide said portion of light from the aperture that is not incident on the optical element to the ambient light sensor.

Such an arrangement may be particularly suitable for embodiments using a movable lens. The lens may be supported by a support structure such as, for example, the body or an intermediate member connected thereto. For embodiments wherein the optical element is a movable lens, the lens may be movably mounted to the support structure (which may be opaque). This free movement provides a gap between the lens and the support structure. In existing camera modules, an opaque shield is provided around the support structure. In some embodiments of the present disclosure, the at least one light guide may extend from one or more positions on such an opaque shield to the ambient light sensor (and may extend, for example, at least partially through the support structure).

The at least one light guide may be arranged to receive a portion of light from the aperture that is transmitted by the optical element and is not incident on the image sensor and to guide said portion of light to the ambient light sensor.

Generally, the optical lens in a camera module has a circular geometry and is operable to form a circular image of a field of view in a plane of the image sensor (which may be referred to as an image plane). However, typically the image sensor comprises a rectangular array of sensing elements. Therefore, the rectangular image sensor only samples a portion of the circular image (and may be considered to crop the circular image). Typically, a portion of the image plane that lies outside of the image sensor is provided with a black material to maximize absorption of the light incident thereon. In some embodiments of the present disclosure, the at least one light guide may extend from one or more positions on the portion of the image plane that lies outside of the image sensor to the ambient light sensor. For example, at least part of the black material may be replaced with transparent material (or one or more apertures).

In some embodiments, the ambient light sensor comprises at least one light sensing element arranged to receive a portion of light from the aperture that is transmitted by the optical element and is not incident on the image sensor.

For example, the or each light sensing element may be disposed adjacent the image sensor. The or each light sensing element may be disposed in substantially the same plane as the image sensor.

The image sensor may be arranged to receive radiation from the aperture and the ambient light sensor may be arranged to receive a portion of said radiation that is transmitted by the image sensor.

Such embodiments may exploit the fact that the image sensor transmits part of the light incident thereon. This transmitted light can be measured using a sufficiently sensitive ambient light sensor die. A suitable calibration algorithm may be used to overcome spectrum distortion due to the silicon transmissivity characteristics. Advantageously, the image sensor may act as a diffusor, which may increase the field of view of the ambient light sensor.

The image sensor may comprise a pixel die of a multilayer stacked CMOS sensor and the ambient light sensor may be provided on another die of the multilayer stacked CMOS sensor.

Multilayer stacked CMOS sensors include two-layer stacked CMOS sensors and three-layer stacked CMOS sensors. A two-layer stacked CMOS sensor may comprise a pixel die bonded to a logic circuit die. Similarly, a three-layer stacked CMOS sensor may comprise a pixel die, a memory die (for example providing dynamic random access memory, DRAM) and a logic circuit die. The multiple dies may be interconnected using through-silicon vias (TSV). Additional through-silicon vias (which may or may not be provided with metal) may be provided in the peripheral portion of the pixel die to increase transmission of light to the ambient light sensor.

The ambient light sensor may be provided on a memory die or a logic circuit die of the multilayer stacked CMOS sensor.

The ambient light sensor may be provided on a peripheral portion of the other die of the multilayer stacked CMOS sensor.

The apparatus may further comprise a spectral filter arranged to limit a bandwidth of radiation from the aperture that is received by the ambient light sensor.

The apparatus may further comprise a diffusor arranged scatter radiation from the aperture that is received by the ambient light sensor.

According to a second aspect of the present disclosure there is provided a mobile electronic device comprising the apparatus of the first aspect of the present disclosure.

The mobile electronic device may further comprise a display screen. The mobile electronic device may further comprise a controller or processor. The controller or processor may be arranged to receive a signal indicative of an ambient light level determined by the ambient light sensor. The controller or processor may be arranged to control a brightness of the display screen in dependence on said signal received from the ambient light sensor.

### BRIEF DESCRIPTION OF THE PREFERRED EMBODIMENTS

Some embodiments of the disclosure will now be described by way of example only and with reference to the accompanying drawings, in which:

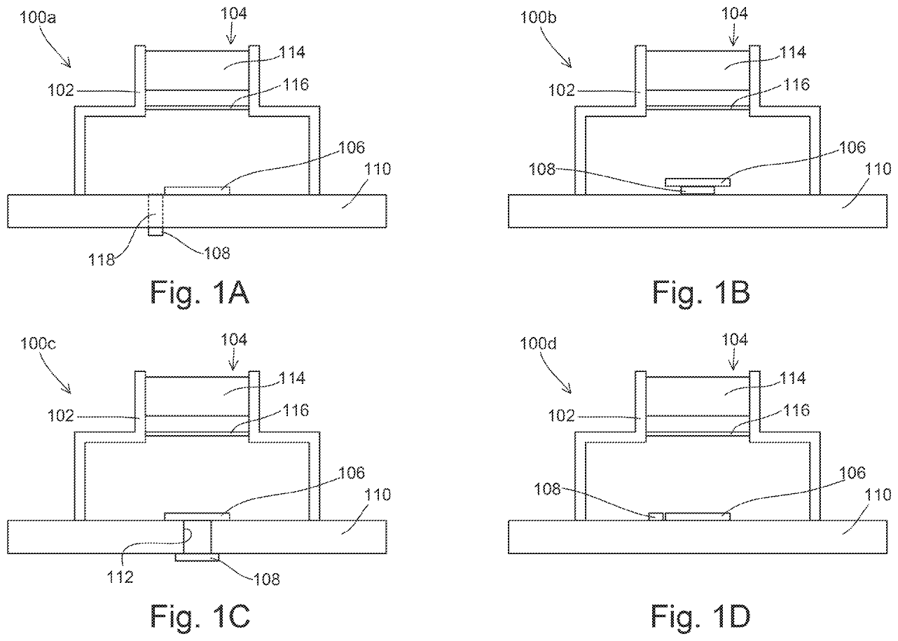

FIG. 1A shows a schematic cross-sectional view of a first apparatus in accordance with the present disclosure;

FIG. 1B shows a schematic cross-sectional view of a second apparatus in accordance with the present disclosure;

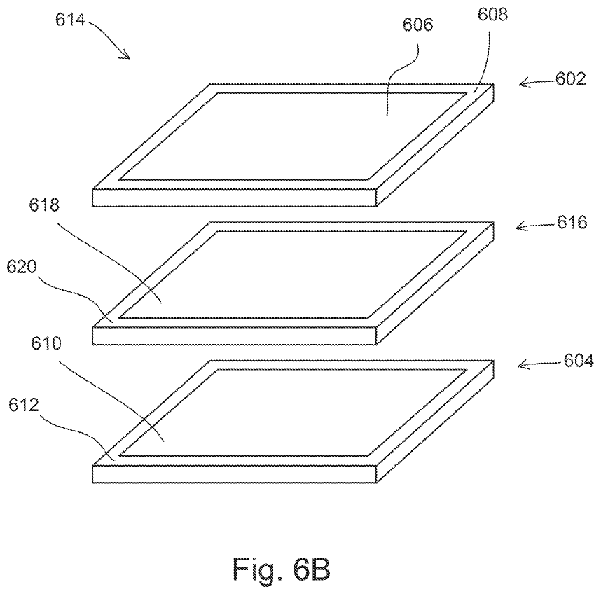

FIG. 10 shows a schematic cross-sectional view of a third apparatus in accordance with the present disclosure;

FIG. 1D shows a schematic cross-sectional view of a fourth apparatus in accordance with the present disclosure;

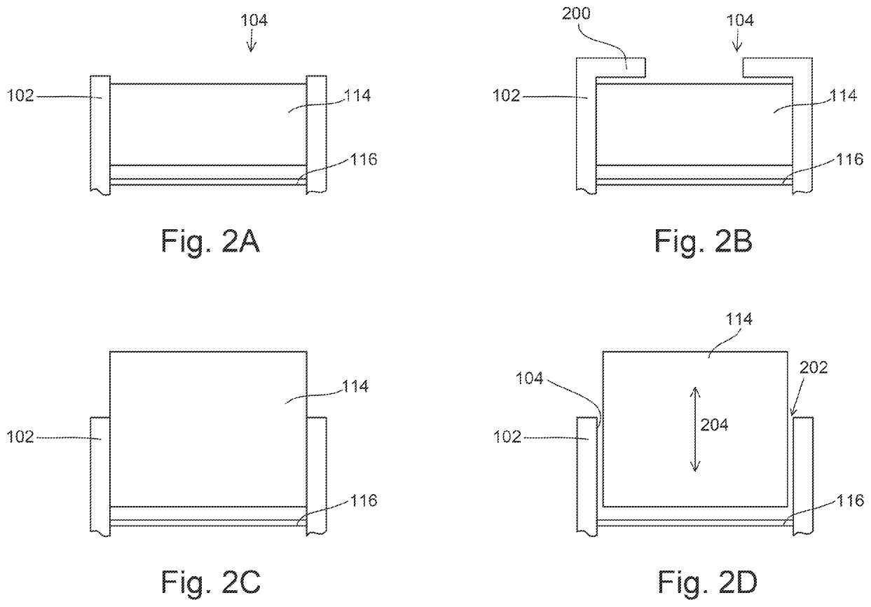

FIGS. 2A-2D show four different example arrangements of the body, aperture and optical element of the apparatus shown in FIGS. 1A to 1D;

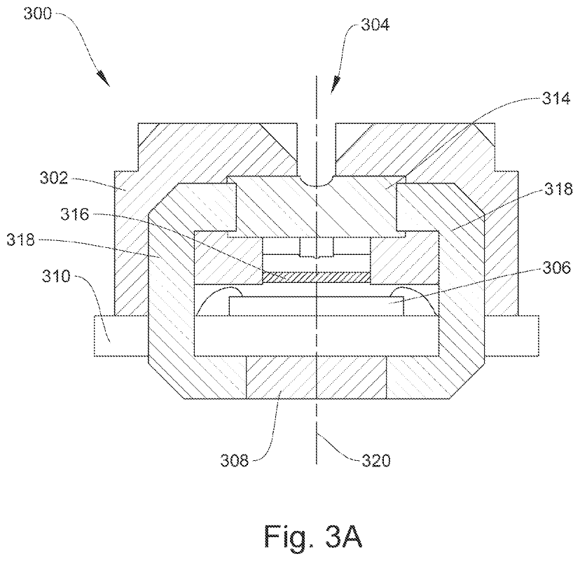

FIG. 3A is a cross-sectional view of a first camera module (having fixed focal length);

FIG. 3B shows a schematic plan view of the printed circuit board of the first camera module shown in FIG. 3A;

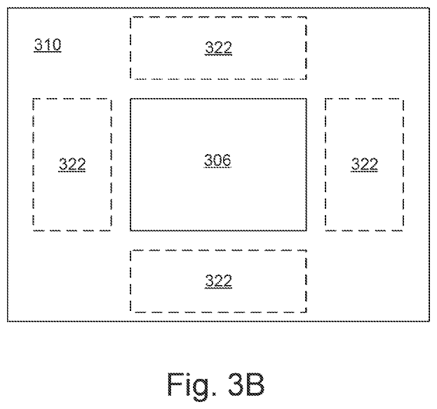

FIG. 4 is a schematic cross-sectional view of a second camera module (having a movable lens so as to provide focal adjustments);

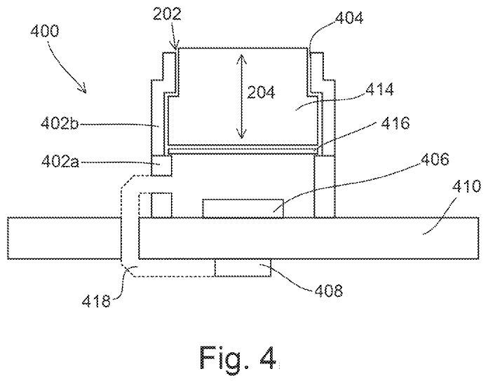

FIG. 5 is a schematic view of an image plane showing a circular image formed by an optical element, a rectangular portion of the circular image sampled by an image sensor and two portions of the image plane that lie within the circular image but outside of the rectangular portion;

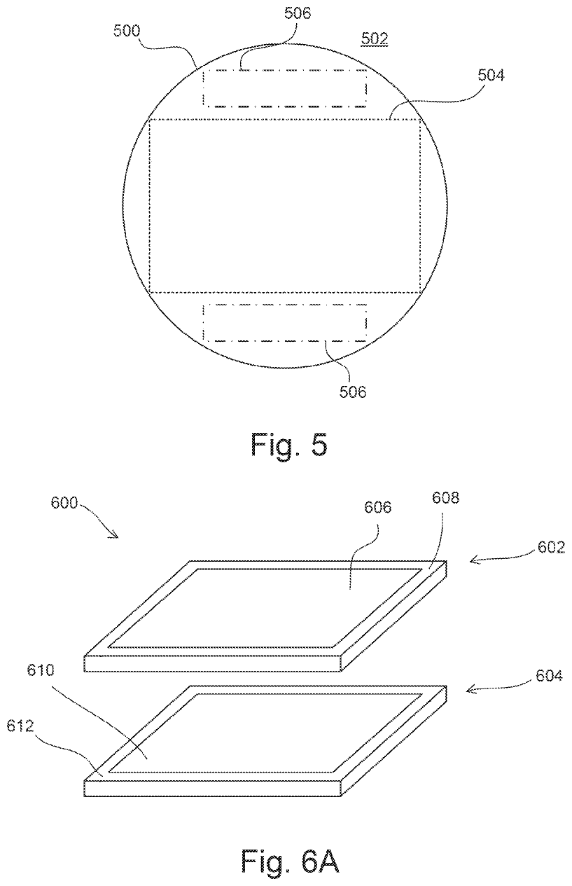

FIG. 6A is a schematic exploded view of a two-layer stacked CMOS sensor; and

FIG. 6B is a schematic exploded view of a three-layer stacked CMOS sensor.

### DETAILED DESCRIPTION OF THE PREFERRED EMBODIMENTS

Generally speaking, the disclosure provides an apparatus comprising both an image sensor and an ambient light sensor, which each receive radiation (for example visible light) from a common aperture. This arrangement is advantageous since it allows the ambient light sensor to be integrated into a camera module of a mobile electronic device. The disclosure may be considered to disclose an apparatus that is generally of the form of a camera module of a mobile electronic device and which has been adapted to include an ambient light sensor that is arranged to receive ambient light from an aperture that also provides light to an image sensor of the camera module. This allows, for example, the ambient light sensor and the image sensor to share a common support or printed circuit board (PCB). Advantageously, this can reduce the size of a bezel of the mobile electronic device. In turn, this allows the size of a screen of the mobile electronic device to be increased. The proposed solution does not require a transmissive screen and therefore can be used with mobile electronic devices comprising an LCD display (or other light blocking display technologies). In addition, the proposed solution can offer advantages when used with mobile electronic devices comprising partially transparent display screens such as, for example, OLED displays (relative, for example, to an arrangement wherein an ambient light sensor is provided behind the screen). First, the transmissivity of an OLED display screen is typically very low (of the order of 2%). Second, for an arrangement wherein an ambient light sensor is provided behind an OLED screen, any ambient light measurement may be subject to a background signal from the screen display content, which may need to be corrected for. Furthermore, by supplying both an image sensor and a separate ambient light sensor, the two sensors can each be separately optimised for their intended uses.

Some examples of the solution are given in the accompanying figures.

FIGS. 1A to 1D each show a schematic representation of an apparatus 100a, 100b, 100c, 100d respectively according to the present disclosure.

Each of the apparatus 100a, 100b, 100c, 100d shown in FIGS. 1A to 1D comprises: a body 102 defining an aperture 104; an image sensor 106 comprising an array of sensing elements; and an ambient light sensor 108.

The image sensor 106 comprises an array of sensing elements. As referred to herein the image sensor 106 comprising an array of sensing elements is intended to mean an array of photosensitive elements each of which is operable to produce a signal in response to a received dose of radiation (for example visible light). That is, the image sensor 106 is intended to mean a portion of a sensor which converts received radiation (for example visible light) into electrical signals and which defines the pixel geometry of the sensor. The image sensor 106 may comprise, for example, an active-pixel sensor technology. For example, the image sensor 106 may comprise, for example, an array of complimentary metal-oxide semiconductor (CMOS) pixels. As referred to herein the image sensor 106 may or may not also comprise any associated memory buffer or logic circuitry. For example, a two-layer stacked CMOS sensor may comprise a pixel die bonded to a logic circuit die. Similarly, a three-layer stacked CMOS sensor may comprise a pixel die, a memory die (for example providing dynamic random access memory, DRAM) and a logic circuit die. As used herein, the term image sensor 106 is intended to include the pixel die but may or may not include the other dies, as will be discussed further below.

The ambient light sensor 108 may comprise any type of photodetector. For example, the ambient light sensor 108 may comprise one or more phototransistors, photodiodes and/or photonic integrated circuits.

In each of the apparatus 100a, 100b, 100c, 100d shown in FIGS. 1A to 1D, the image sensor 106 and the ambient light sensor 108 are each arranged to receive radiation from the aperture 104. However, this can be achieved by a plurality of different arrangements of the image sensor 106 and the ambient light sensor 108. As will be discussed further below, in each of the apparatus 100a, 100b, 100c, 100d shown in FIGS. 1A to 1D schematically represents a different arrangement of the image sensor 106 and the ambient light sensor 108 such that the image sensor 106 and the ambient light sensor 108 both receive radiation from the aperture 104.

In some embodiments of the apparatus 100a, 100b, 100c, 100d shown in FIGS. 1A to 1D, the image sensor 106 and the ambient light sensor 108 are formed on separate dies. For example, the array of sensing elements of the image sensor 106 may be formed on an image sensor die and the ambient light sensor 108 may be formed on a separate ambient light sensor die.

In some embodiments of the apparatus 100a, 100b, 100c, 100d shown in FIGS. 1A to 1D, the image sensor 106 and the ambient light sensor 108 are formed using different (lithographic) process nodes. It will be appreciated that the image sensor 106 and the ambient light sensor 108 being formed using different process nodes is intended to mean that the smallest features formed on the image sensor 106 are different to the smallest features formed on the ambient light sensor 108. For example, the ambient light sensor 108 may comprise one or more photodetectors formed from a 180 nm process node whereas the image sensor 106 may comprise an array of sensing elements that define a plurality of image pixels and which may be formed from a significantly smaller process node. It will be appreciated that each individual sensing element of the image sensor 106 may comprise a plurality of components. For example, each individual sensing element of the image sensor 106 may comprise: a microlens, a spectral filter, a photodiode and a plurality of transistors and connecting wires. The pixel die of a stacked CMOS image sensor may, for example, be formed from a 90 nm process node, a 45 nm process node or a smaller process node. The pixel die of a stacked CMOS image sensor may, for example, use backside illumination (BSI) technology.

In each of the apparatus 100a, 100b, 100c, 100d shown in FIGS. 1A to 1D, the image sensor 106 and the ambient light sensor 108 are supported by a common printed circuit board (PCB) 110. The printed circuit board (PCB) 110 may be considered to be a common support substrate. It will be appreciated that in other embodiments, the image sensor 106 and the ambient light sensor 108 may be supported by separate PCBs.

In the embodiments of the apparatus 100a, 100c, 100d shown in FIGS. 1A, 1C and 1D, the image sensor 106 and the ambient light sensor 108 are be mounted separately on the PCB 110.

In the embodiment of the apparatus 100b shown in FIG. 1B, the image sensor 106 and the ambient light sensor 108 are shown in a stacked configuration. For such an embodiment of the apparatus 100b (as shown in FIG. 1B), the image sensor 106 and the ambient light sensor 108 may be mounted and/or connected separately to the PCB 110. Alternatively, as will be discussed further below with reference to FIGS. 6A and 6B, for such an embodiment of the apparatus 100b (as shown in FIG. 1B), the image sensor 106 die and the ambient light sensor 108 die may be stacked to form a three-dimensional integrated circuit. For example, the image sensor die 106 and the ambient light sensor die 108 may be interconnected using through-silicon vias (TSVs).

In the embodiments of the apparatus 100a, 100c shown in FIGS. 1A and 10, the ambient light sensor 108 is disposed on an opposite side of the PCB 110 to the image sensor 106. However, as will be described further below, in a variant of the embodiment of the apparatus 100a shown in FIG. 1A, the ambient light sensor 108 may be disposed on the same side of the PCB 110 as the image sensor 106.

For embodiments wherein the ambient light sensor 108 is disposed on an opposite side of the PCB 110 to the image sensor 106, the image sensor 106 may be disposed in a side or surface of the support substrate 110 facing the aperture 104. As shown in FIG. 1D, one or more holes, through bores or apertures 112 may be provided in the PCB 110 in the vicinity of the ambient light sensor 108 (or at least the photosensitive part of the ambient light sensor 108). This may increase a signal received by the ambient light sensor 108.

Each of the apparatus 100a, 100b, 100c, 100d shown in FIGS. 1A to 1D may be an assembly or module that can, in use, form part of a mobile electronic device. For example, each of the apparatus 100a, 100b, 100c, 100d shown in FIGS. 1A to 1D may provide a camera module for a mobile electronic device. The body 102 defining the aperture 104 may, in use, be engaged with, mounted to, or connected to a body of a mobile electronic device. In use, the image sensor 106 and the ambient light sensor 108 may be housed in a volume defined by the body 102 defining the aperture and the body of a mobile electronic device.

Optionally, each of the apparatus 100a, 100b, 100c, 100d shown in FIGS. 1A to 1D further comprises an optical element 114 supported by the body 102 and disposed in the vicinity of the aperture 104. The optical element 114 is arranged to project at least a portion of radiation received by the aperture 104 onto the image sensor 106. The body 102 may be coupled (either directly or indirectly) to the PCB 110, which supports the image sensor 106 and the ambient light sensor 108. In addition to defining the aperture, the body 102 provides the function of positioning the optical element 114 relative to the image sensor 106.

The optical element 114 supported by the body 102 and disposed in the vicinity of the aperture 104. Furthermore, the optical element 114 is arranged to project at least a portion of radiation received by the aperture 104 onto the image sensor 106. However, it will be appreciated that the arrangement of the body 102, aperture 104 and optical element 114 shown in FIGS. 1A to 1D is schematic and that in other embodiments, the arrangement may differ. As a non-limiting example, FIGS. 2A to 2D show four different arrangements of the body 102, aperture 104 and optical element 114.

The arrangement shown in FIG. 2A is substantially the same as that shown in FIGS. 1A to 1D. Here the optical element 114 is disposed within the body 102 proximate the aperture 104. An external dimension or diameter of the optical element 114 may generally match an internal dimension or diameter of the body 102 in the vicinity of the aperture 104.

The arrangement shown in FIG. 2B is substantially the same as that shown in FIG. 2A although a flange 200 is provided on the body 102. The flange 200 may be generally annular in shape. The aperture 104 is defined by the flange 200 such that a dimension of the aperture is smaller than the external dimension of the optical element 114 (which still generally matches an internal dimension of the body 102 in the vicinity of the aperture 104).

The arrangements shown on FIGS. 2A and 2B may be suitable for fixed focal length arrangements.

The arrangement shown in FIG. 2C is substantially the same as that shown in FIG. 2A although the optical element 114 partially extends out of the aperture 104 defined by the body 102. It will be appreciated that in such embodiments, the optical element 114 may comprise one or more lenses (for example a compound lens comprising a plurality of lens elements) provided in a housing.

The arrangement shown in FIG. 2D is substantially the same as that shown in FIG. 2C although there are gaps 202 formed between the optical element 114 and the body 102. Such an arrangement may be provided, for example, when the optical element 114 is coupled to the body 102 in such a way so as to allow free movement of the optical element 114 (relative to the body 102) in the direction indicated by arrow 204. To facilitate such movement gaps will be formed between the optical element 114 and the body 102. For example, when the optical element 114 is coupled to the body 102 via a voice coil motor (VCM) to allow free movement of the optical element 114 (relative to the body 102) in the direction indicated by arrow 204.

The optical element 114 may comprise a lens. Additionally or alternatively, the optical element may comprise other refractive and/or reflective optics including, for example, prisms. The optical element 114 may be a compound lens comprising a plurality of lens elements and is therefore represented in the schematic cross-sectional views of FIGS. 1A to 1D as a rectangle. The optical element 114 may be arranged to form an image of a field of view on the image sensor 106.

In some embodiments, the optical element 114 may comprise a fixed-focus lens. Alternatively, in other embodiments, the optical element 114 may comprise a lens provided with an adjustment mechanism operable to control a focal length of the lens and/or a position of the lens relative to the image sensor 106. For example, the optical element 114 may comprise a lens that is coupled to the body 102 via a voice coil motor (VCM) to allow free movement of the lens (relative to the image sensor 106).

In the embodiments of the apparatus 100b, 100c shown in FIGS. 1B and 10, the image sensor 106 is disposed between the aperture 104 defined in the body 102 and the ambient light sensor 108. Such arrangements may be described as having the ambient light sensor 108 positioned behind the image sensor 106. Such an arrangement is advantageous in that it allows both the ambient light sensor 108 and the image sensor 106 to overlap (in a plane of the PCB 110) and to occupy substantially the same position on a bezel of a mobile electronic device comprising the apparatus 100b, 100c. In turn, this allows the size of a screen of the mobile electronic device to be increased.

Advantageously, the apparatus 100a, 100b, 100c, 100d shown in FIGS. 1A to 1D comprises both an image sensor 106 and an ambient light sensor 108 which each receive radiation (for example visible light) from a common aperture 104. This arrangement is advantageous since it allows the ambient light sensor 108 to be integrated into a camera module of a mobile electronic device. For example, the body 102 and image sensor 106 may form part of a camera module of a mobile electronic device with which the ambient light sensor 108 has been integrated. This allows the ambient light sensor 108 and the image sensor 106 to share a common PCB 110. Advantageously, this allows for a reduction in the size of the bezel of a mobile electronic device comprising the apparatus 100a, 100b, 100c, 100d (relative to a mobile electronic device comprising a camera module and a separate ambient light module). In turn, this allows the size of a screen of the mobile electronic device to be increased. The apparatus 100a, 100b, 100c, 100d is particularly, though not exclusively, suitable for use as a front facing camera module of a mobile electronic device (i.e. a camera module provided on the same surface as the screen of the mobile electronic device).

The apparatus 100a, 100b, 100c, 100d does not require a transmissive screen (for example it can be used with phones comprising an LCD display). In addition, such an arrangement can reduce the amount of background signal generated by a screen of the mobile electronic device. This allows for more accurate measurement of ambient light levels and/or reduces the complexity of calibration of such ambient light level measurements.

Furthermore, by supplying both an image sensor 106 and a separate ambient light sensor 108, the two sensors can each be separately optimised for their intended use. For example, it may be desirable for an image sensor 106 may be optimised to maximise a density of sensing elements (pixels) and therefore to provide optimum sensitivity of the small individual sensing elements or pixels. In contrast, it may be desirable for an ambient light sensor 108 to use a larger sensing element having a greater dynamic range (to allow it to operate both in high and low ambient light levels).

Optionally, each of the apparatus 100a, 100b, 100c, 100d shown in FIGS. 1A to 1D further comprises a spectral filter 116 arranged limit a bandwidth of radiation from the aperture 104 that is received by the image sensor 106 and/or the ambient light sensor 108. It may, for example, be desirable to provide an infrared filter 116 (which substantially absorbs or blocks infrared radiation) such that only visible ambient radiation is incident on the image sensor 106 and/or the ambient light sensor 108.

In each of the apparatus 100a, 100b, 100c, 100d shown in FIGS. 1A to 1D, the image sensor 106 and the ambient light sensor 108 are each arranged to receive radiation from the aperture 104. Therefore, each of the apparatus 100a, 100b, 100c, 100d shown in FIGS. 1A to 1D, comprises an optical pathway from the aperture 104 to the ambient light sensor 108. However, this optical pathway can be achieved by a plurality of different arrangements of the image sensor 106 and the ambient light sensor 108. As now discussed, in each of the apparatus 100a, 100b, 100c, 100d shown in FIGS. 1A to 1D schematically represents a different arrangement of the image sensor 106 and the ambient light sensor 108 wherein the image sensor 106 and the ambient light sensor 108 both receive radiation from the aperture 104 (i.e. wherein there is an optical pathway from the aperture 104 to the ambient light sensor 108).

In the embodiment of the apparatus 100a shown in FIG. 1A, the apparatus 100a further comprises at least one light guide 118 arranged to receive a portion of light from the aperture 104 and to guide said portion of light from the aperture 104 to the ambient light sensor 108.

In some variant embodiments of the apparatus 100a shown in FIG. 1A, the image sensor 106 may be disposed between the aperture 104 defined in the body 102 and the ambient light sensor 108 (i.e. the ambient lights sensor 108 is behind the image sensor 106). For such variant embodiments of the apparatus 100a shown in FIG. 1A, the at least one light guide 118 may be arranged to receive the portion of light from the aperture 104 and to guide said portion of light from the aperture 104 around the image sensor 106 and to the ambient light sensor 108. Such a variant embodiments of the apparatus 100a shown in FIG. 1A will be described further below with reference to FIGS. 3A to 4B.

For embodiments comprising at least one light guide 118 arranged to receive a portion of light from the aperture 104 and to guide said portion of light from the aperture 104 to the ambient light sensor 108, it may be challenging to provide an ambient light sensor 108 with a sufficient field of view to achieve an accurate determination of an ambient light level. As discussed further below, the field of view of the ambient light sensor mat be increased if the apparatus 100a comprises plurality of light guides 118, each arranged to receive a portion of light from the aperture 104 and to guide said portion of light from the aperture 104 to the ambient light sensor 108.

Optionally, the ambient light sensor 108 may comprise a plurality of light sensing elements. Each of the plurality of light guides 118 may be arranged to receive a portion of light from the aperture 104 and to guide said portion of light from the aperture 104 to a different one of the plurality of light sensing elements.

Optionally, the apparatus 100a may comprise a diffusor (not shown) arranged to scatter light received by the or each light guide 118 before it is incident on the ambient light sensor 108. Such a diffusor can improve the field of view of the ambient light sensor 108.

In the embodiments of the apparatus 100b, 100c shown in FIGS. 1B and 10, the image sensor 106 is arranged to receive radiation directly from the aperture 104 and the ambient light sensor 108 is arranged to receive a portion of said radiation that is transmitted by the image sensor 106. That is, the ambient light sensor 108 is arranged to receive radiation indirectly from the aperture, via the image sensor 106. Such embodiments may exploit the fact that the image sensor 106 transmits part of the light incident thereon. This transmitted light can be measured using a sufficiently sensitive ambient light sensor 108 die. A suitable calibration algorithm may be used to overcome spectrum distortion due to the silicon transmissivity characteristics. Advantageously, the image sensor 106 may act as a diffusor, which may increase the field of view of the ambient light sensor 108.

In the embodiment of the apparatus 100b shown in FIG. 1B, the ambient light sensor 108 is disposed on the same side of the PCB 110 as the image sensor 106. In the embodiment of the apparatus 100c shown in FIG. 10, the ambient light sensor 108 is disposed on an opposite side of the PCB 110 to the image sensor 106. The apparatus 100b shown in FIG. 1B may be particularly suitable for integrating the ambient light sensor 108 into a multilayer stacked CMOS sensor, along with the image sensor 106. Such an arrangement is discussed further below with reference to FIGS. 6A and 6B. The apparatus 100c shown in FIG. 10 may be particularly suitable if the image sensor 106 and the ambient sensor 108 are to be separately coupled to the PCB 110 (as this may simplify the two sets of connections).

In the embodiment of the apparatus 100d shown in FIG. 1D, the ambient light sensor 108 comprises at least one light sensing element arranged to receive a portion of light from the aperture 104 that is transmitted by the optical element 114 and is not incident on the image sensor 106. For example, as indicated schematically, the or each light sensing element of the ambient light sensor 108 may be disposed adjacent the image sensor 106. The or each light sensing element of the ambient light sensor 108 may be disposed in substantially the same plane as the image sensor 106.

Some specific implementations of the apparatus 100a shown schematically in FIG. 1A are now discussed with reference to FIGS. 3A to 5.

FIG. 3A is a cross-sectional view of a first camera module 300 having fixed focal length.

The first camera module 300 comprises: a body 302, an aperture 304, an image sensor 306, a printed circuit board (PCB) 310, an optical element 314, and an infrared filter 316. As used here, the term infrared filter 316 is intended to mean a component which substantially absorbs or blocks infrared radiation (and may pass visible radiation). Features of the first camera module 300 which generally correspond to features of the apparatus 100a shown schematically in FIG. 1A have reference numerals given by the reference numeral of the corresponding feature of the apparatus 100a shown in FIG. 1A but which start with a 3 rather than a 1. For example, the optical element 314 in FIG. 3A corresponds to the optical element 114 shown in FIG. 1A.

The body 302 may comprise a base body portion and the upper body portion which are releasably engagable (for example via mutually engageable threaded portions) so as to form a two part body.

The optical element 314 may be a compound lens comprising a plurality of lens elements which are supported by the body 302.

The camera module 300 further comprises a plurality of light guides 318 and the ambient light sensor 308. As will be explained further below with reference to FIG. 3B, in this embodiment, the camera module 300 comprises four light guides 318 although it will be appreciated that other embodiments may have different numbers of light guides. Each of the plurality of light guides 318 is arranged to receive a portion of light scattered to a side or edge of the optical element 314 and to guide said portion of light scattered to a side or edge of the optical element 314 to the ambient light sensor 308.

It will be appreciated that light which is scattered to a side or edge of the optical element 314 may comprise light which is scattered out of the optical element in a direction generally away from an optical axis 320 of the optical element. That is, light that is scattered to a side or edge of the optical element 314 propagates in a direction having at least a component that is generally perpendicular to the optical axis 320 of the optical element 314.

The optical element 314 may comprise a compound lens having a plurality of lens elements. Each single lens element may comprise two opposed surfaces at least one of which is either concave or convex. For example, the lens elements may each have two opposed convex surfaces. The side or edge of a single lens element may be a surface of the lens disposed between the two opposed surfaces. It will be appreciated that since the optical element 314 is a compound lens scattering of light to the side or edge of the optical element 314 will in general also include light which exits the compound lens in between the individual lens elements.

The optical element 314 is supported by the body 302, which may, for example, be a two part body formed by a base body portion and an upper body portion. In particular, when the base body portion and the upper body portion are engaged with each other, the optical element 314 may be held captive therebetween. The body 302 may be considered to provide a support structure.

In general, the body 302 may be opaque (to reduce or prevent background light that bypasses the optical element 314 from being incident on the image sensor 306). However, the plurality of light guides 318 are at least partially formed in the body 302, extending from one or more positions to a side or edge of the optical element 314 towards the ambient light sensor 308. Although in this embodiment, the plurality of light guides 318 are at least partially formed in the body 302, it will be appreciated that various different body arrangements may be employed in different embodiments (see, for example, FIGS. 2A to 2D and the accompanying discussion above). In general, at least one light guide 318 may be at least partially formed in part of the body or support structure.

Each of the plurality of light guides 318 may be provided with, or may act as, a diffusor. For example, a diffusor may be provided at or proximate to an entrance to each of the plurality of light guides 318. That is, a diffusor may be provided at or proximate a part of each of the plurality of light guides 318 that is proximate to a side or edge of the optical element 314. Each diffusor may substantially cover an entrance of a corresponding light guide 318. Each such diffusor may be provided as a separate optical component (to a corresponding light guide 318) and which is arranged to scatter light incident thereon. Alternatively, each such diffusor may be integrated with a corresponding light guide 318. For example, each such diffusor may be provided by a surface of each light guide (which surface may define an entrance of the light guide 318) that is provided with a texture or surface roughness that is arranged to scatter light which enters the light guide 318.

In this embodiment, each of the plurality of light guides 318 further extends through the PCB 310 to the ambient light sensor 308 (which is disposed on an opposite side of the PCB 310 to the image sensor 306 in a similar arrangement to that shown in FIG. 1a). In this embodiment, each of the plurality of light guides 318 extends to a single ambient light sensor 308.

In an alternative arrangement, the ambient light sensor 308 may comprise a plurality of ambient light sensing elements which may each be disposed on the same side of the PCB 310 as the image sensor. For such alternative embodiments, the plurality of light guides 318 do not extend through the PCB 310.

FIG. 3B shows a schematic plan view of the PCB 310, showing the position of the image sensor 306. Also shown are four positions 322 which correspond to each of the four light guides 318.

FIG. 4 is a schematic cross-sectional view of a second camera module 400 having a movable lens so as to provide focal adjustments.

The second camera module 400 comprises: a base body portion 402a an upper body portion 402b, an aperture 404, an image sensor 406, an ambient light sensor 408, a printed circuit board (PCB) 410, an optical element 414, and an infrared filter 416. As used here, the term infrared filter 416 is intended to mean a component which substantially absorbs or blocks infrared radiation (and may pass visible radiation). Features of the second camera module 400 which generally correspond to features of the apparatus 100a shown schematically in FIG. 1A have reference numerals given by the reference numeral of the corresponding feature of the apparatus 100a shown in FIG. 1A but which start with a 4 rather than a 1. For example, the optical element 414 in FIG. 4 corresponds to the optical element 114 shown in FIG. 1A.

The base body portion 402a and the upper body portion 402b are releasably engagable so as to form a two part body that corresponds to the body 102 shown in FIG. 1A.

The optical element 414 may be a compound lens comprising a plurality of lens elements. The optical element 414 is supported by the two part body formed by the base body portion 402a and the upper body portion 402b.

The optical element 414 is coupled to the upper body portion 402b in such a way so as to allow free movement of the optical element 414 (relative to the upper body portion 402b) in the direction indicated by arrow 204. To facilitate such movement gaps 202 are formed between the optical element 414 and the upper body portion 402b. For example, the upper body portion 402b may comprise a voice coil motor (VCM) to allow free movement of the optical element 414 relative thereto. The upper body portion 402b and the optical element 414 are therefore arranged in a similar way to the body 102 and the optical element 214 shown in FIG. 2D.

The second camera module 400 further comprises at least one light guide 418. It will be appreciated that other embodiments may have different numbers of light guides. The light guide 418 is arranged to receive a portion of light from the aperture 404 that is not incident on the optical element 414 and to guide said portion of light from the aperture 404 that is not incident on the optical element 414 to the ambient light sensor 408.

The gaps 202 formed between the optical element 414 and the upper body portion 402b together with the light guide 418 provide a light path allowing ambient radiation to propagate to the ambient light sensor 408. In some existing arrangements, there are already gaps in the lower body portion 402a and therefore it is known to provide a metal light shield around the upper and lower body portions 402a, 402b. It will be appreciated that for such arrangements the light guide 418 may be formed in said metal light shield.

The optical element 414 is movably supported by the two part body formed by the base body portion 402a and the upper body portion 402b. In particular, when the base body portion 402a and the upper body portion 402b are engaged with each other, the optical element 414 is held captive therebetween (allowing for some limited range of movement). The base body portion 402a and the upper body portion 402b may be considered to provide a support structure.

As now discussed, with reference to FIG. 5, in some embodiments of the apparatus 100a shown in FIG. 1A the at least one light guide 118 is arranged to receive a portion of light from the aperture 104 that is transmitted by the optical element 114 and is not incident on the image sensor 106 and to guide said portion of light to the ambient light sensor 108. Such an arrangement is shown in FIG. 1A.

Generally, the optical element 114 in a camera module has a circular geometry and, as shown in FIG. 5, is operable to form a circular image 500 of a field of view in a plane 502 of the image sensor 106 (which may be referred to as an image plane). However, typically the image sensor 106 comprises a rectangular array of sensing elements. Therefore, the rectangular image sensor 106 only samples a rectangular portion 504 of the circular image 500 (and may be considered to crop the circular image 500). Typically, a portion of the image plane 502 that lies outside of the image sensor is provided with a black material to maximize absorption of the light incident thereon. In some embodiments, the at least one light guide 118 extend from one or more positions 506 on the portion of the image plane 502 that lies within the circular image 500 formed by the optical element 114 but outside of the rectangular portion 504 sampled by the image sensor 106. For example, at least part of the black material may be replaced with transparent material (or one or more apertures).

In the alternative, in some embodiments, one or more ambient light sensing elements may be provided in the image plane 502 within one or more positions 506 that lie within the circular image 500 formed by the optical element 114 but lie outside of the rectangular portion 504 sampled by the image sensor 106. Such an arrangement is shown in FIG. 1D.

A specific implementation of the apparatus 100b shown schematically in FIG. 1B is now discussed with reference to FIGS. 6A and 6B.

As explained above, in the apparatus 100b shown schematically in FIG. 1B the image sensor 106 is arranged to receive radiation from the aperture 104 and the ambient light sensor 108 is arranged to receive a portion of said radiation that is transmitted by the image sensor 106. Such embodiments exploit the fact that the image sensor 106 may transmit part of the light incident thereon. This transmitted light can be measured using a sufficiently sensitive ambient light sensor 108. A suitable calibration algorithm may be used to overcome spectrum distortion due to the silicon transmissivity characteristics. Advantageously, the image sensor 106 may act as a diffusor, which may increase the field of view of the ambient light sensor 108.

In some embodiments, the image sensor 106 and the ambient light sensor 108 are each provided in different dies of a multilayer stacked CMOS sensor.

Multilayer stacked CMOS sensors include two-layer stacked CMOS sensors and three-layer stacked CMOS sensors.

A two-layer stacked CMOS sensor 600 is shown in FIG. 6A. The two-layer stacked CMOS sensor 600 comprises a pixel die 602 bonded to a logic circuit die 604. The pixel die 602 comprises a central portion 606 containing the array of sensing elements and a peripheral portion 608. The pixel die 602 of the two-layer stacked CMOS sensor 600 may, for example, use backside illumination (BSI) technology. Similarly, the logic circuit die 604 comprises a central portion 610 containing logic circuits and a peripheral portion 612. The pixel die 602 and the logic circuit die 604 are interconnected using through-silicon vias (TSV). In particular, the peripheral portion 608 of the pixel die 602 is connected to the peripheral portion 612 of the logic circuit die 604.

A three-layer stacked CMOS sensor 614 is shown in FIG. 6B. The three-layer stacked CMOS sensor 614 also comprises a pixel die 602 and a logic circuit die 604. In addition, the three-layer stacked CMOS sensor 614 also comprises a memory die 616 in between the pixel die 602 and the logic circuit die 604. The memory die 616 comprises a central portion 618 containing memory circuits (for example providing dynamic random access memory, DRAM) and a peripheral portion 620. The pixel die 602 and the memory die 616 are interconnected using through-silicon vias (TSV). In particular, the peripheral portion 608 of the pixel die 602 is connected to the peripheral portion 620 of the memory circuit die 616. The memory die 616 and the logic circuit die 604 are interconnected using through-silicon vias (TSV). In particular, the peripheral portion 620 of the memory die 616 is connected to the peripheral portion 612 of the logic circuit die 604.

In some embodiments, the image sensor 106 comprises a pixel die 602 of a multilayer stacked CMOS sensor 600, 614 and the ambient light sensor 108 is provided on another die 604, 616 of the multilayer stacked CMOS sensor 600, 614.

In some embodiments, the ambient light sensor 108 is provided on a memory die 616 or a logic circuit die 604 of a multilayer stacked CMOS sensor 600, 614. For example, the ambient light sensor 108 may be provided on peripheral portion 612, 620 of the other die 604, 616 of the multilayer stacked CMOS sensor 600, 614.

In some embodiments, additional through-silicon vias (which may or may not be provided with metal) may be provided in the peripheral portion 608 of the pixel die 602 and/or the peripheral portion 620 of the memory die 616 to increase transmission of light to the ambient light sensor 108.

Embodiments of the present disclosure can be employed in many different applications including any type of mobile electronic device such as, for example, a mobile telephone, tablet or laptop.

### LIST OF REFERENCE NUMERALS

100a first apparatus according to the present disclosure
100b second apparatus according to the present disclosure
100c third apparatus according to the present disclosure
100d fourth apparatus according to the present disclosure
102 body
104 aperture
106 image sensor 106
108 ambient light sensor
110 printed circuit board (PCB)
112 holes, through bores or apertures
114 optical element
116 spectral filter
118 at least one light guide
200 flange
202 gaps between optical element and body
204 arrow indicating movement of optical element relative to body
300 first camera module
302 body
304 aperture
306 image sensor
308 ambient light sensor
310 printed circuit board (PCB)
314 optical element
316 infrared filter
318 plurality of light guides
320 optical axis (of the optical element)
322 positions which correspond to the light guides
400 second camera module
402a upper body portion
402b lower body portion
404 aperture
406 image sensor
408 ambient light sensor
410 printed circuit board (PCB)
414 optical element
416 infrared filter
418 light guide
500 circular image formed by optical element
502 image plane
504 rectangular portion 504 of the circular image sampled by image sensor
506 positions on a portion of the image plane that lies within the circular image
15 formed by the optical element but outside of the rectangular portion
sampled by the image sensor
600 two-layer stacked CMOS sensor
602 pixel die
604 logic circuit die
606 central portion of pixel die
608 peripheral portion of pixel die
610 central portion of logic circuit die
612 peripheral portion of logic circuit die
614 three-layer stacked CMOS sensor
616 memory die
618 central portion of memory die
620 peripheral portion of memory die

It will be appreciated that as used herein the terms “screen”, “display” and “display screen” are synonymous with each other and may be used interchangeably.

The skilled person will understand that in the preceding description and appended claims, positional terms such as ‘above’, ‘along’, ‘side’, etc. are made with reference to conceptual illustrations, such as those shown in the appended drawings. These terms are used for ease of reference but are not intended to be of limiting nature. These terms are therefore to be understood as referring to an object when in an orientation as shown in the accompanying drawings.

Although the disclosure has been described in terms of preferred embodiments as set forth above, it should be understood that these embodiments are illustrative only and that the claims are not limited to those embodiments. Those skilled in the art will be able to make modifications and alternatives in view of the disclosure which are contemplated as falling within the scope of the appended claims. Each feature disclosed or illustrated in the present specification may be incorporated in any embodiments, whether alone or in any appropriate combination with any other feature disclosed or illustrated herein.

1. An apparatus comprising:
a body defining an aperture;
an image sensor comprising an array of sensing elements; and
an ambient light sensor,
wherein the image sensor and the ambient light sensor are each arranged to receive radiation from the aperture.

2. The apparatus of claim 1, wherein the array of sensing elements of the image sensor is formed on an image sensor die and the ambient light sensor is formed on a separate ambient light sensor die.

3. The apparatus of claim 2, wherein the separate dies of the image sensor and the ambient light sensor are both supported by a common support substrate.

4. The apparatus of claim 3, wherein the ambient light sensor is disposed on an opposite side of the common support substrate to the image sensor.

5. The apparatus of claim 2, wherein the image sensor die and the ambient light sensor die are stacked to form a three-dimensional integrated circuit.

6. The apparatus of claim 1, wherein the image sensor and the ambient light sensor are formed using different process nodes.

7. The apparatus of claim 1, further comprising an optical element supported by the body, the optical element being arranged to project at least a portion of the radiation received by the aperture onto the image sensor.

8. The apparatus of claim 7, wherein the optical element comprises a fixed-focus lens.

9. The apparatus of claim 7, wherein the optical element comprises a lens provided with an adjustment mechanism operable to control a focal length of the lens and/or a position of the lens relative to the image sensor.

10. The apparatus of claim 1, wherein the image sensor is disposed between the aperture defined in the body and the ambient light sensor.

11. The apparatus of claim 1, further comprising at least one light guide arranged to receive a portion of light from the aperture and to guide said portion of light from the aperture to the ambient light sensor.

12. The apparatus of claim 11, wherein the apparatus comprises a plurality of light guides, each arranged to receive a portion of light from the aperture and to guide said portion of light from the aperture to the ambient light sensor.

13. The apparatus of claim 11, wherein the apparatus comprises a diffusor arranged to scatter light received by the plurality of light guides before it is incident on the ambient light sensor.

14. The apparatus of claim 7, further comprising at least one light guide arranged to receive a portion of light from the aperture and to guide said portion of light from the aperture to the ambient light sensor, wherein the at least one light guide is arranged to receive a portion of light scattered to a side or edge of the optical element and to guide said portion of light scattered to a side or edge of the optical element to the ambient light sensor.

15. The apparatus of claim 7, further comprising at least one light guide arranged to receive a portion of light from the aperture and to guide said portion of light from the aperture to the ambient light sensor, wherein the at least one light guide is arranged to receive a portion of light from the aperture that is not incident on the optical element to guide said portion of light from the aperture that is not incident on the optical element to the ambient light sensor.

16. The apparatus The apparatus of claim 7, further comprising at least one light guide arranged to receive a portion of light from the aperture and to guide said portion of light from the aperture to the ambient light sensor, wherein the at least one light guide is arranged to receive a portion of light from the aperture that is transmitted by the optical element and is not incident on the image sensor and to guide said portion of light to the ambient light sensor.

17. The apparatus of claim 7, wherein the ambient light sensor comprises at least one light sensing element arranged to receive a portion of light from the aperture that is transmitted by the optical element and is not incident on the image sensor.

18. The apparatus of claim 1, wherein the image sensor is arranged to receive radiation from the aperture and wherein the ambient light sensor is arranged to receive a portion of said radiation that is transmitted by the image sensor.

19. The apparatus of claim 18, wherein the image sensor comprises a pixel die of a multilayer stacked CMOS sensor and wherein the ambient light sensor is provided on another die of the multilayer stacked CMOS sensor.

20. The apparatus of claim 19, wherein the ambient light sensor is provided on a memory die or a logic circuit die of the multilayer stacked CMOS sensor.

21. The apparatus of claim 19, wherein the ambient light sensor is provided on a peripheral portion of the other die of the multilayer stacked CMOS sensor.

22. The apparatus of claim 1, further comprising a spectral filter arranged to limit a bandwidth of radiation from the aperture that is received by the ambient light sensor.

23. The apparatus of claim 1, further comprising a diffusor arranged scatter radiation from the aperture that is received by the ambient light sensor.

24. A mobile electronic device comprising the apparatus of claim 1.
